(19) United States
(12) Patent Application Publication
(10) Pub. No.: US 2014/0139864 A1
(43) Pub. Date: May 22, 2014

(54) FILE MANAGEMENT APPARATUS, FILE MANAGEMENT METHOD, AND FILE MANAGEMENT SYSTEM

(71) Applicant: Makato HARIGAE, Tokyo (JP)

(72) Inventor: Makato HARIGAE, Tokyo (JP)

(21) Appl. No.: 13/680,989

(22) Filed: Nov. 19, 2012

(51) Int. Cl. G06F 3/12

(52) U.S. Cl. CPC G06F 3/1293
USPC 358/1.15

(57) ABSTRACT

According to one embodiment, a file management apparatus includes an operation panel, a communication unit configured to communicate with a device by near field radio communication, and a control unit configured to receive information about files stored in the device, display file names of the files on a display unit of the operation panel, accept one or more passwords given to the files by a user as a inputted through the operation panel, and transmit the passwords given to the files to the device.

### FIELD

Embodiments described herein relate generally to a file management apparatus, a file management method, and a file management system.

### BACKGROUND

A near field communication technology is adopted in some devices. In recent years, the technology has allowed large amounts of data to be transferred at a high speed. With near field communication technology, radio communication is executed by, for example, aligning an antenna of a device with an antenna of a communication partner apparatus. Examples of such near field communication technology include Bluetooth® and TransferJet®.

An image forming apparatus such as an MFP (Multi Function Peripheral) employs near field communication technology to receive a transfer of image data from mobile devices. However, some mobile devices may not have a sufficient and easily installable security function for near field communication. It may be difficult to install an advanced information access system to provide security in some mobile devices.

Therefore, there is demand for a technique for securely accessing information from a device having near field communication capabilities.

### BRIEF DESCRIPTION OF THE DRAWINGS

FIG. 1 is a perspective view of an MFP according to an embodiment;

FIG. 2 is a block diagram of components of the MFP that perform a copy function according to an embodiment;

FIG. 3 is a block diagram of a control system of the MFP according to an embodiment;

FIG. 4 is an external view of an operation panel provided in the MFP according to an embodiment;

FIG. 5A is a schematic diagram of a top view of the MFP according to an embodiment;

FIG. 5B is a schematic diagram of a side view of the MFP according to an embodiment;

FIG. 6 is a block diagram of a control system for near field communication between the MFP and a device, according to an embodiment;

FIG. 7 is a flowchart that illustrates a file information setting procedure between the MFP and the device, according to an embodiment;

FIG. 8 is a schematic diagram of a file information setting screen displayed on the MFP, according to an embodiment;

FIG. 9 is a schematic diagram of a state of files in the device, according to an embodiment;

FIG. 10 is a flowchart that illustrates a file data processing procedure between the MFP and the device, according to an embodiment;

FIG. 11 is a schematic diagram of a password input screen displayed on the MFP, according to an embodiment;

FIG. 12 is a schematic diagram of a file processing screen displayed on the MFP, according to an embodiment; and

FIG. 13 is a flowchart for illustrating a file deletion processing procedure of the device, according to an embodiment.

### DETAILED DESCRIPTION

In general, according to one embodiment, a file management apparatus includes: an operation panel; a communication unit configured to communicate with a device by near field radio communication; and a control unit configured to receive information about files stored in the device, display file names of the files on a display unit of the operation panel, accept one or more passwords given to the files by a user as inputted through the operation panel, and transmit the passwords given to the files to the device.

According to another embodiment, a method of obtaining access to files stored in a device via near field radio communication includes: requesting the device to transmit information about the stored files; receiving the information about the stored files from the device; accepting one or more passwords that a user has inputted through an operation panel; associating the passwords with the files; and transmitting the passwords to the device.

Another embodiment provides a file management system comprising a file management apparatus and a device configured to perform exchange of information via near field radio communication. The file management apparatus includes: an operation panel; a first control unit configured to receive information about files stored in the device, display file names of the files on a display unit of the operation panel, accept one or more passwords given to the file by a user as inputted through the operation panel, and transmit the passwords given to the files to the device. The device includes a second control unit configured to transmit the information about the files stored in the device to the file management apparatus, receive the passwords given to the files from the file management apparatus, and store the passwords associated with the files.

An MFP (Multi Function Peripheral) is a type of an image forming apparatus. The MFP is a digital compound function machine for comprehensively utilizing various functions of office equipment such as a copy function, an image transmitting/receiving function via a facsimile network, an image data transmitting/receiving function via E-mail, and a print function over a network.

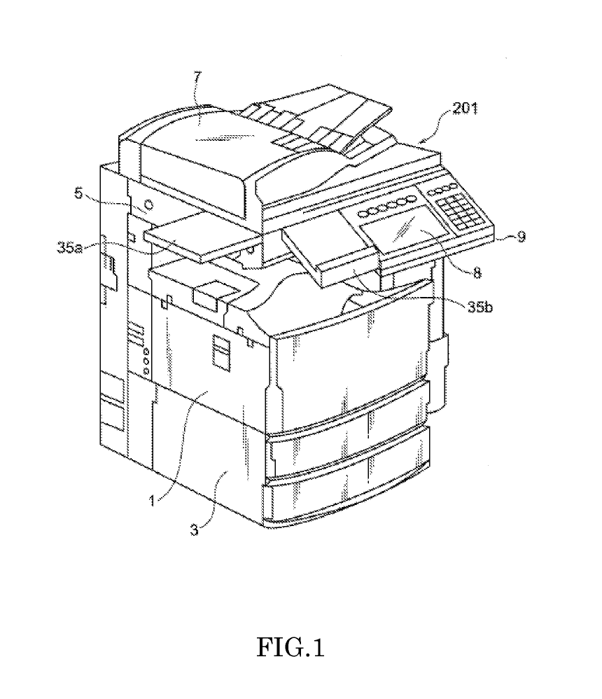

FIG. 1 is a perspective view of an MFP according to an embodiment. The MFP 201 includes a printing unit 1, a sheet tray 3, a scanning unit 5, an auto feed unit 7, and an operation panel 9. The MFP 201 includes a cradle 35a, 35b for a device having near field communication capabilities.

The printing unit 1 prints an image on a medium. The sheet tray 3 supplies a medium to the printing unit 1. The scanning unit 5 captures image information from an original document as image data. The auto feed unit 7 feeds an original document to a reading position, and discharges the original document from the reading position to a discharged position. The operation panel 9 is an instruction input unit that instructs the MFP 201 to perform operations such as the start of image formation in the printing unit 1 and the start of reading of image information of an original document by the scanning unit 5. The operation panel 9 includes an LCD 8 for inputting an instruction and displaying information to an operator.

The MFP 201 may be connected to a network or communication line to receive image data by facsimile, E-mail, or the like.

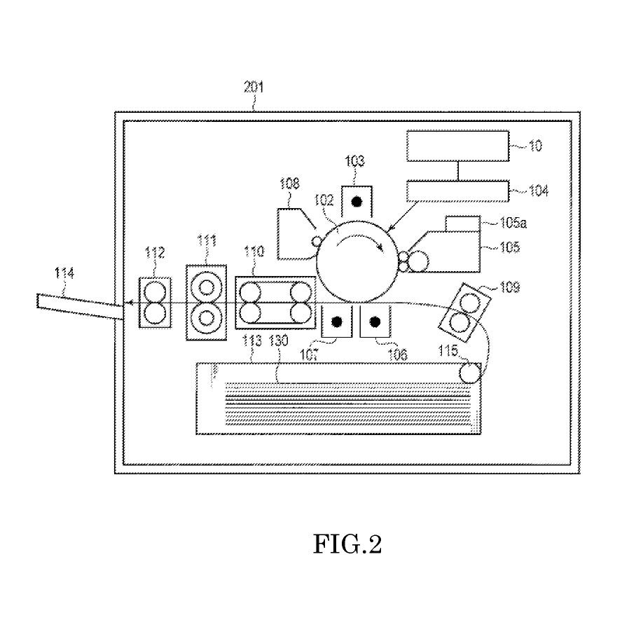

FIG. 2 is a block diagram of components of the MFP 201 that perform a copy function.

The MFP 201 includes a control unit 10, a photoconductive drum 102, a charging device 103, a scanning and exposing unit 104, a developing device 105, a transfer charger 106, a peeling charger 107, a cleaner 108, a paper feeding unit 109, a sheet conveying unit 110, a fixing device 111, a paper discharge unit 112, and a paper discharge tray 114.

The photoconductive drum 102 rotates in a sub-scanning direction, which is a circumferential direction of the photoconductive drum 102. The charging device 103 is arranged in the vicinity of the photoconductive drum 102. The charging device 103 uniformly charges the surface of the photoconductive drum 102. The scanning and exposing unit 104 emits light and extinguishes light according to an image signal. A laser beam emitted from the semiconductor laser is changed to light that scans in a main scanning direction, which is a rotation axis direction of the photoconductive drum 102, by a deflector such as a polygon mirror. The laser beam is focused on the photoconductive drum 102 by an optical system such as a lens. When the laser beam is irradiated on the charged photoconductive drum 102, the potential of a region on which the laser beam is irradiated drops and an electrostatic latent image is formed.

The developing device 105 forms a toner image on the photoconductive drum 102 by applying a developer to the photoconductive drum 102. On the other hand, the paper feeding roller 115 separates sheets 130 in the sheet tray 3 one by one and feeds the sheet 130 to the paper feeding unit 109. The paper feeding unit 109 feeds the sheet 130 to a transfer position of the photoconductive drum 102. The transfer charger 106 transfers the toner image onto the fed sheet 130. The peeling charger 107 peels the sheet 130 off the photoconductive drum 102.

The sheet 130 having the toner image transferred thereon is conveyed by the sheet conveying unit 110. The fixing device 111 fixes the toner image on the sheet 130. The paper discharge unit 112 discharges the sheet 130 having an image fixed thereon to the paper discharge tray 114.

After the peeling charger 107 peels the sheet 130, residual toner on the photoconductive drum 102 is removed by the cleaner 108. The photoconductive drum 102 returns to an initial state and changes to a standby state for the next image formation. An image forming operation is continuously performed by repeating the process steps described above.

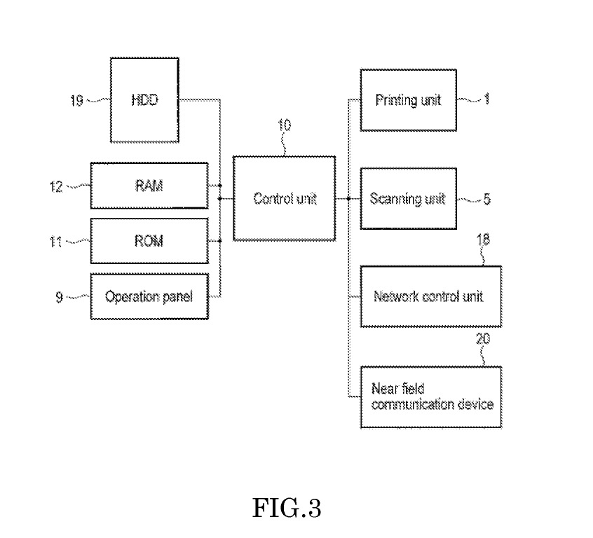

FIG. 3 is a block diagram of a control system of the MFP 201.

The MFP 201 includes the control unit 10, a ROM 11, a RAM 12, a network control unit 18, an internal storage device (e.g. a HDD) 19, and near field communication device 20 in addition to the printing unit 1 (including the sheet tray 3), the scanning unit 5, and the operation panel 9 (including the LCD 8). These units are connected via a system bus.

The control unit 10 controls the hardware units connected via the system bus. The ROM 11 stores various control programs for the MFP 201. The RAM 12 is a buffer memory that temporarily stores data generated during execution of the control programs.

The network control unit 18 is an interface for exchanging of information via a network such as the Internet. The HDD 19 is a nonvolatile storage medium set on the inside of the MFP 201.

The near field communication device 20 exchanges information by near field radio communication with an external device.

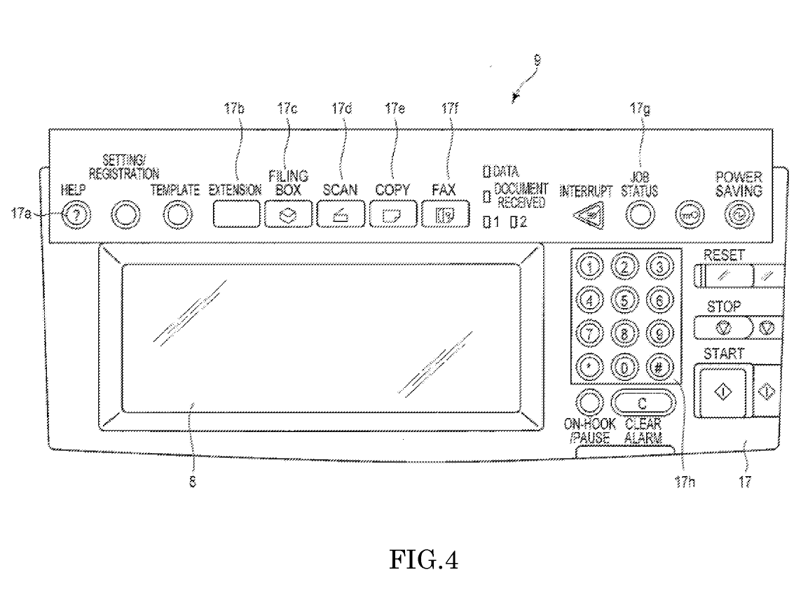

FIG. 4 is an external view of the operation panel 9 provided in the MFP 201. A user inputs settings and checks the settings for the MFP 201 via the operation panel 9. The operation panel 9 includes the LCD 8 and an operation unit 17. The LCD 8 is configured with a touch panel. The LCD 8 displays a state of the MFP 201, an operation procedure, various instructions to the user, and the like. The operation unit 17 may includes various operation buttons for operating the MFP 201.

As keys for invoking screens for selecting and setting functions, the operation unit 117 has a help button 17a, a function extension button 17b, a filing box button 17c, a scan button 17d, a copy button 17e, a facsimile button 17f, a status check button 17g, number keys 17h, and the like, for inputting setting values and checking information.

The functions of main buttons among the operation buttons are explained below. The user uses the help button 17a when inquiring, for example, what kind of operation should be performed next. The user operates the extension button 17b when using an extension function. The user uses the filing box button 17c when extracting stored image data. The user uses the scan button 17d when using a scan function. The user uses the copy button 17e when using a copy function. The user uses the facsimile button 17f when using a facsimile function. The user uses the status check button 17g when displaying an execution status of the MFP 201. The user uses the number keys 17h when inputting a number.

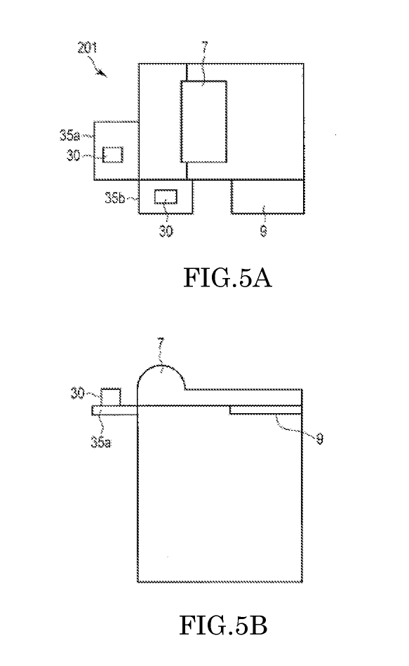

FIG. 5A is a schematic diagram of a top view of the MFP 201. FIG. 5B is a schematic diagram of a side view of the MFP 201 according to this embodiment. A cradle 35a (or a cradle 35b) is provided on the MFP 201 as a reception for the device 30. An antenna (not shown in the figure) is provided in the cradle 35a (or the cradle 35b). An antenna (not shown in the figure) is provided in the device 30. The MFP 201 and the device 30 exchange information via the antennas.

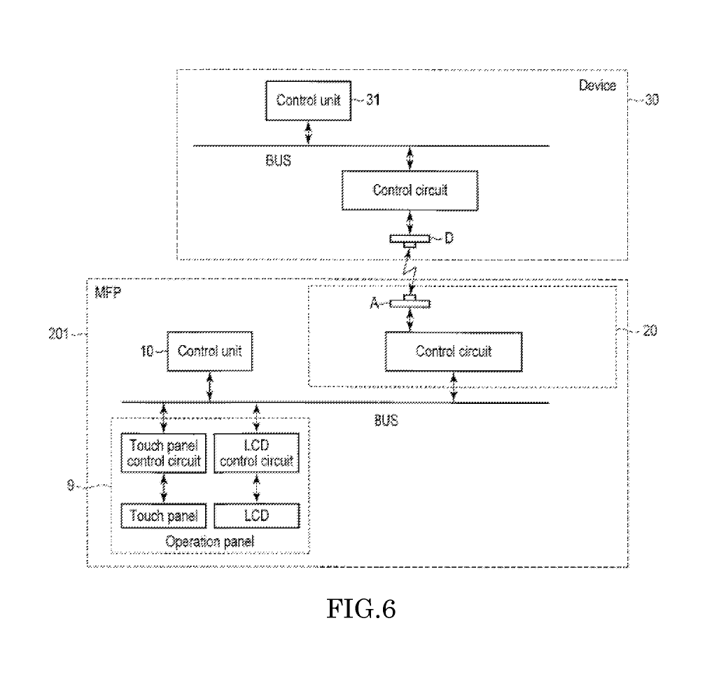

FIG. 6 is a block diagram of a control system for near field communication between the MFP 201 and the device 30, according to an embodiment.

The control unit 10 of the MFP 201 controls a control circuit of a near field communication device 20. The control circuit of the near field communication device 20 controls transmission and reception of a radio signal by an antenna A. The control unit 10 controls a touch panel control circuit to acquire input information from the touch panel and controls an LCD control circuit to display output information and the like on the LCD 8. The control unit 31 of the device 30 includes a memory. The control unit 31 controls transmission and reception of a radio signal by an antenna D of a near field communication device. Data transfer between the MFP 201 and the device 30 is performed by radio wave transmission and reception between the antenna A and the antenna D.

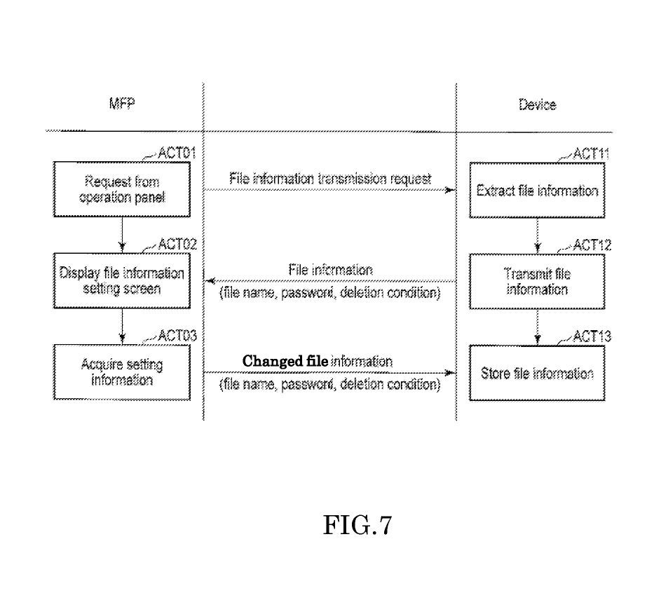

A method of accessing information by the MFP 201 from the device 30 is explained below. The method includes a file information setting mode and a file data processing mode. FIG. 7 is a flowchart that illustrates a file information setting procedure between the MFP 201 and the device 30 according to this embodiment.

The user may put the device 30 on the cradle 35a. In Act 01, the user requests to the MFP 201 to acquire information concerning files stored in the device 30 (hereinafter referred to as file information). The user may select the file information setting mode by the operation panel 9. The MFP 201 may require the user to input of a password for activating the file information setting mode. The MFP 201 transmits a file information transmission request to the device 30.

In Act 11, the device 30 receives the file information transmission request from the MFP 201. The device 30 extracts file information stored in the device 30. The file information includes file names, passwords (explained below), and deletion conditions (explained below). In Act 12, the device 30 transmits the file information to the MFP 201. In Act 02, the MFP 201 displays a file information setting screen on the operation panel 9.

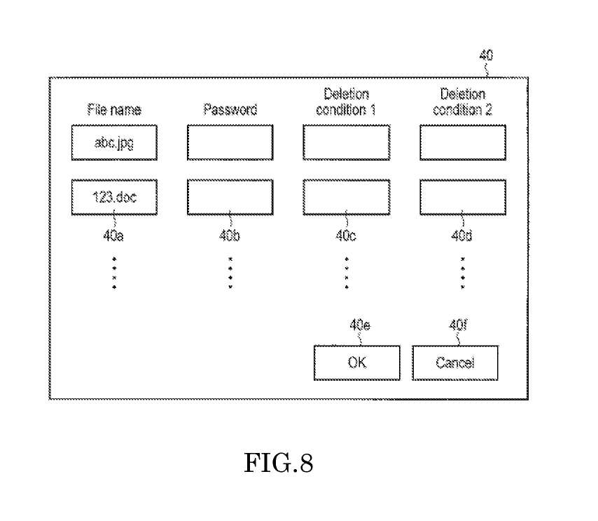

FIG. 8 is a schematic diagram of a file information setting screen 40 displayed on the MFP 201.

The file information setting screen 40 includes file name areas 40a, password spaces 40b, deletion condition 1 spaces 40c, deletion condition 2 spaces 40d, an OK button 40e, and a cancel button 40f. The transmitted file names are displayed in the file name areas 40a. The passwords transmitted from the device 30 are displayed masked form in the password spaces 40b. If passwords are not set, blanks are displayed. Using the file information setting screen 40, the transmitted deletion conditions (deletion conditions 1 and deletion conditions 2) are respectively displayed in the deletion condition 1 spaces 40c and the deletion condition 2 spaces 40d. If deletion conditions are not set, blanks are displayed. The user may set information in the password spaces 40b, the deletion condition 1 spaces 40c, and the deletion condition 2 spaces 40d.

The password may be set for each file. The deletion condition 1 represents a period in which the file is to be stored. As the deletion condition 1, a value may be set in a unit of D (day), W (week), or M (month). For example, if 2 M (two months) is set as the deletion condition 1, the file is deleted from the device 30 at a point when two months has elapsed from generation of the file.

The deletion condition 2 represents a type of an event for deleting the file. For example, printing, FAX, storage, and the like may be designated as such the event. If the printing is set therein, the file is deleted from the device 30 when the file is printed by the MFP 201. If the FAX is set therein, the file is deleted from the device 30 when the file is sent by facsimile from the MFP 201. If the storage is set therein, the file is deleted from the device 30 when the file is stored in a memory of the MFP 201.

In Act 03, the MFP 201 acquires file setting information inputted by the user via the file information setting screen 40 and transmits a changed file information to the device 30.

In Act 13, the device 30 receives and stores the changed file information. The device 30 may execute the file information setting procedure after authenticating that the user has authority to set file information. If possible, the device 30 may independently execute the file information setting procedure without performing communication with the MFP 201.

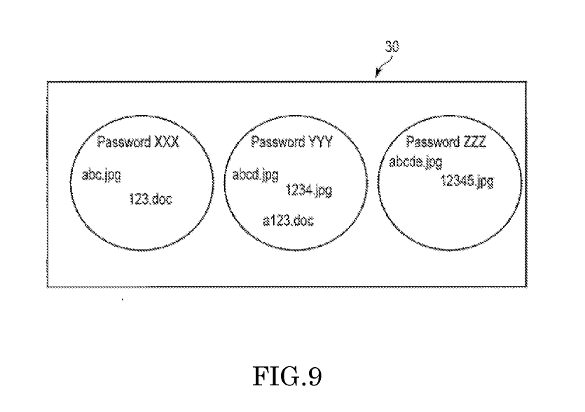

FIG. 9 is a schematic diagram of states of files in the device 30. The device 30 may manage a plurality of passwords and grouping of some files which has same password.

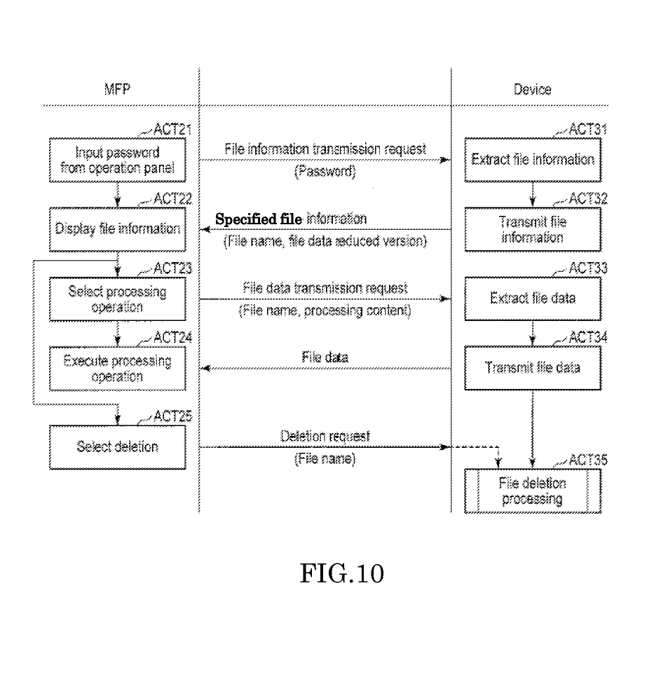

FIG. 10 is a flowchart that illustrates a file data processing procedure between the MFP 201 and the device 30, according to an embodiment.

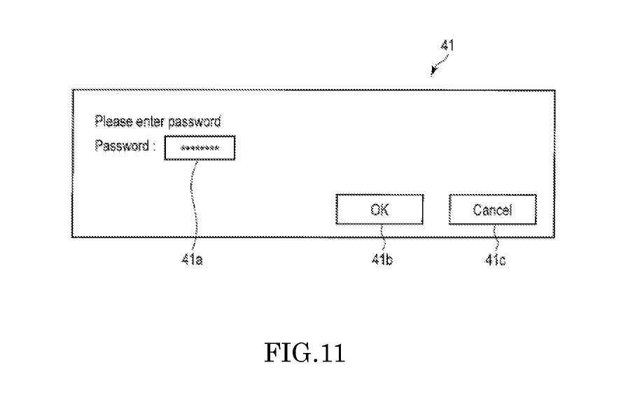

The user may put the device 30 on the cradle 35a. The MFP may automatically start the file data processing mode. In Act 21, the MFP 201 displays a password input screen on the operation panel 9. FIG. 11 is a schematic diagram of a password input screen 41 displayed on the MFP 201. The user enters a password in a password space 41a and presses an OK button 41b according to a message displayed on the password input screen 41. The MFP 201 transmits a file information transmission request attached with the password to the device 30.

In Act 31, the device 30 receives the file information transmission request attached with the password. The device 30 specifies some files including the password from the files stored in the device 30. The device 30 extracts a specified file information includes a file name, a reduced version (a thumbnail version) of file data and the like. In Act 32, the device 30 transmits the specified file information to the MFP 201.

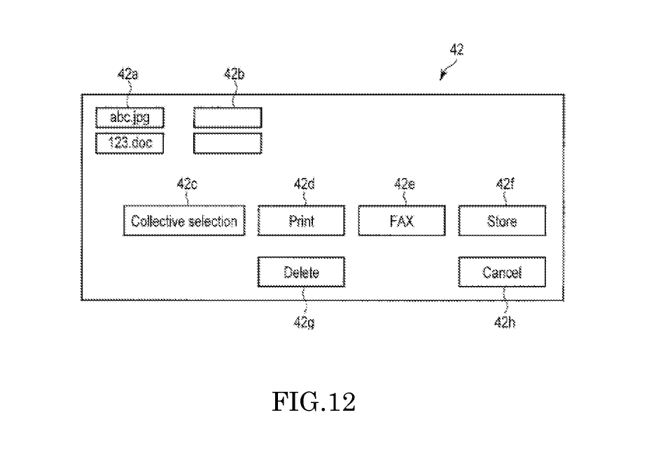

In Act 22, the MFP 201 displays a file processing screen on the operation panel 9 based on the specified file information transmitted from the device 30. FIG. 12 is a schematic diagram of a file processing screen 42 displayed on the MFP 201.

The file processing screen 42 includes file name areas 42a, reduced version display areas 42b, a collective selection button 42c, a print button 42d, a FAX button 42e, a store button 42f, a delete button 42g, and a cancel button 42h. The user may determine a file to be processed referring to images displayed in the reduced version display areas 42b.

If the user touches the file name area 42a, the background of the file name area 42a is reversed in color. The user permits to select a plurality of files by touching the respective file name areas 42a. If the user presses the collective selection button 42c, the user may select all displayed files.

Subsequently, the user may cause the MFP 201 to start a processing operation by pressing any one of the print button 42d, the FAX button 42e, and the store button 42f. If the user presses the delete button 42g, the user may cause the MFP 201 to delete a selected file. If the user presses the cancel button 42h, the user may reset setting of file selection.

If the user selects a file and presses any one of the print button 42d, the FAX button 42e, and the store button 42f in Act 23, the MFP 201 transmits a file data transmission request for requesting data of the selected file to the device 30. The file data transmission request includes a name of the selected file and a processing operation for the file. The processing operation is any one of printing, transmitting by facsimile network and storing in the HDD 19.

In Act 33, the device 30 extracts data of the selected file based on the file data transmitting request. In Act 34, the device 30 transmits the selected file data to the MFP 201. In Act 35, the device 30 executes file deletion processing. The file deletion processing is explained below.

In Act 24, the MFP 201 receives the selected file data from the device 30. The MFP 201 may execute the selected processing operation using the selected file data.

If the user selects a file and presses the delete button 42g in Act 25, the MFP 201 transmits a deletion request for requesting deletion of the selected file to the device 30. The deletion request includes a name of the selected file. In Act 35, the device 30 receives the deletion request from the MFP 201. The device 30 may execute the file deletion processing based on the file name included the file deletion request.

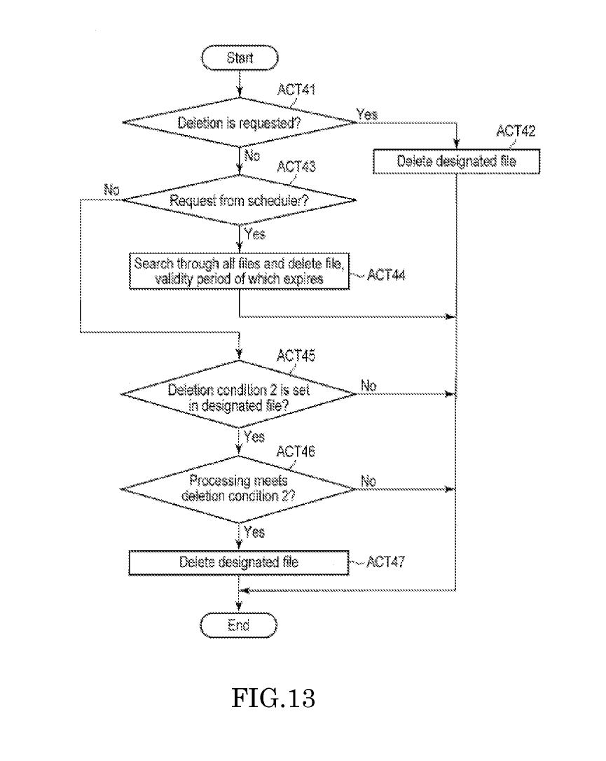

FIG. 13 is a flowchart for illustrating a file deletion processing procedure of the device 30, according to an embodiment. The file deletion processing is activated at three timings explained below. First timing is time when a deletion request for requesting deletion of a file is transmitted from the MFP 201. Second timing is time when the device 30 transmits file data in response to a transmission request for file data from the MFP 201. Third timing is time when a scheduler of the device 30 detects that predetermined time comes. For example, the third timing is time when a date is updated.

The device 30 checks a cause of the activation. In Act 41, the device 30 checks whether the cause of the activation is a deletion request. If the cause of the activation is the deletion request (YES in Act 41), in Act 42, the device 30 deletes a selected file. The device 30 ends this processing.

If the cause of the activation is not the deletion request (NO in Act 41), in Act 43, the device 30 checks whether the cause of the activation is a request from the scheduler. If the cause of the activation is the request from the scheduler (YES in Act 43), in Act 44, the device 30 searches through the deletion conditions 1 of all files and specifies an expired file. The device 20 deletes the expired file. If there is no expired file, the device 30 ends this processing.

If the cause of the activation is not the request from the scheduler (NO in Act 43), in Act 45, the device 30 checks whether the deletion condition 2 is set in the selected file. If the deletion condition 2 is not set (NO in Act 45), the device 30 ends this processing.

If the deletion condition 2 is set (YES in Act 45), the device 30 checks whether processing operation of the MFP 201 meets the deletion condition 2. If the processing operation does not meet the deletion condition 2 (NO in Act 46), the device 30 ends this processing.

If the processing content meets the deletion condition 2 (YES in Act 46), in Act 47, the device 30 deletes the selected file. The device 30 ends this processing.

In this embodiment, the device 30 deletes the file before the MFP 201 executes the processing operation. However, the device 30 may delete the file, after receiving a signal indicating that the processing operation completed successfully from the MFP 201.

According to the embodiment explained above, various effects may be achieved. In the embodiment, a password may be set for each file by the MFP. A file access from an external device is controlled according to the password. Therefore, it is possible to finely and conveniently realize security.

The MFP and the device control a file access in cooperation with each other. The device may search some files based on a password transmitted from the MFP. The MFP is permitted to search some files in the device. Therefore, desired file access control may be executed on a device that has an insufficient operation function.

In the embodiment, the device includes a function of deleting data in the device according to data exchange between the MFP and the device. Therefore, it is possible to prevent unnecessary data from remaining in the device. Further, the device includes a function of automatically deleting data by setting a validity period in data in the device. Therefore, it is possible to prevent unnecessary data from remaining in the device.

In the embodiment, it is explained that the MPF has access to the device. Other external devices may be used as the MFP. The other external devices include, but not limited to, a personal computer which has a near field communication device.

The functions explained in the embodiment may be configured using hardware or may be realized by causing a computer to read a computer program describing the functions using software. The functions may be configured by selecting the software or the hardware as appropriate.

Further, the functions can also be realized by causing the computer to read the computer program stored in a not-shown recording medium. A recording form of the recording medium may be any form as long as the recording medium can record the computer program and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A file management apparatus comprising:
an operation panel;
a communication unit configured to communicate with a device by near field radio communication; and
a control unit configured to receive information about files stored in the device, display file names of the files on a display unit of the operation panel, accept one or more passwords given to the files by a user as inputted through the operation panel, and transmit the passwords given to the files to the device.

2. The apparatus according to claim 1, wherein the control unit is configured to accept one or more deleting conditions given to the files by the user as inputted through the operation panel and transmit the deleting condition to the device.

3. The apparatus according to claim 2, wherein the deleting condition specifies a period after which the file is to be deleted from the device.

4. The apparatus according to claim 2, wherein the deleting condition specifies that the file is to be deleted from the device after a predetermined processing has been executed on the file.

5. The apparatus according to claim 2, wherein
the control unit receives a password that a user as inputted through the operation panel, and transmits a file information transmission request including the password to the device,
the control unit receives file information about one or more files associated with the password,
the display unit displays the file information, and
the control unit receives an input of a file name and a type of processing from the operation panel, and executes the type of processing on a file associated with the file name.

6. The apparatus according to claim 5, wherein the control unit transmits the file name and the type of the processing to the device.

7. The apparatus according to claim 1, further comprising:
a receptacle for the device that is positioned a fixed distance away from an antenna of the communication unit.

8. The apparatus according to claim 7, wherein the fixed distance is within a range of operation of TransferJet® near field communication technology.

9. A method of obtaining access to files stored in a device via near field radio communication, the method comprising:
requesting the device to transmit information about the stored files;
receiving the information about the stored files from the device;
accepting one or more passwords that a user has inputted through an operation panel;
associating the passwords with the files; and
transmitting the passwords to the device.

10. The method according to claim 9, further comprising:
receiving a password that a user has inputted through the operation panel;
receiving file information about one or more files associated with the password;
displaying the file information on a display unit of the operation panel; and
receiving an input of a file name and a type of processing from the operation panel; and
executing the type of processing on a file associated with the file name.

11. The method according to claim 9, wherein
accepting the one or more passwords and one or more deleting conditions given to the files by the user as inputted through the display unit.

12. The method according to claim 11, wherein the deleting condition specifies a period after which the file is to be deleted from the device.

13. The method according to claim 11, wherein the deleting condition specifies that the file is to be deleted from the device after a predetermined processing has been executed on the file.

14. A file management system comprising a file management apparatus and a device configured to perform exchange of information via near field radio, wherein
the file management apparatus includes:
an operation panel;
a first control unit configured to receive information about files stored in the device, display file names of the files on a display unit of the operation panel, accept one or more passwords given to the file by a user as inputted through the operation panel, and transmit the passwords given to the files to the device, and
the device includes a second control unit configured to transmit the information about the files stored in the device to the file management apparatus, receive the passwords given to the files from the file management apparatus, and store the passwords associated with the files.

15. The system according to claim 14, wherein
the first control unit receives a password that a user has inputted through the operation panel, and transmits a file information transmission request including the password,
the first control unit receives file information about one or more files associated with the password,
the display unit displays the file information,
the first control unit receives an input of a file name and a type of processing from the operation panel and executes the type of processing on a file associated with the file name, and
the second control unit receives the file information transmission request from the file management apparatus, and transmits the one or more file information about files associated with the password to the file management apparatus.

16. The apparatus according to claim 14, wherein the control unit is configured to accept one or more deleting conditions given to the files by the user as inputted through the operation panel and transmit the deleting condition to the device.

17. The apparatus according to claim 16, wherein the deleting condition specifies a period after which the file is to be deleted from the device.

18. The apparatus according to claim 17, wherein the second control unit is configured to delete the file from the device after the specified period.

19. The apparatus according to claim 16, wherein the deleting condition specifies that the file is to be deleted from the device after a predetermined processing has been executed on the file.

20. The apparatus according to claim 19, wherein the second control unit is configured to delete the file from the device after the predetermined processing has been executed on the file.
